(19) United States
(12) Patent Application Publication
(10) Pub. No.: US 2005/0085187 A1
(43) Pub. Date: Apr. 21, 2005

(54) Wireless user note server apparatus, methods and computer program products and wireless terminals for use therewith

(76) Inventors: Magnus Jendbro, Lund (SE); Bjorn Hansson, Malmo (SE)

Correspondence Address: Robert M. Meeks;Myers Bigel Sibley & Sajovec, Post Office Box 37428, Raleigh, NC, 27627, US

(21) Appl. No.: 10/688,164

(22) Filed: Oct. 17, 2003

(51) Int. Cl. H04B 7/00

(52) U.S. Cl. 455/41.2; 455/414.1

(57) ABSTRACT

A wireless user note service apparatus includes a short range wireless transceiver, such as a Bluetooth transceiver, and a processor operatively coupled to the short-range wireless transceiver and configured to provide an autonomous wireless user note server that wirelessly receives, locally stores and wirelessly transmits user notes to and from users of the short-range wireless transceiver. The autonomous wireless user note server may be operative to wirelessly receive, locally store and wirelessly transmit user notes without storing geographical location data in association with the user notes. The autonomous wireless user note server may also be configured to wireless receive, locally store and wirelessly transmit user notes without communicating the user notes to a central wireless user note repository that stores notes associated with multiple locations. The autonomous wireless user note server may be further operative to selectively transmit locally stored user notes bases on at least one of a recipient identity and a user note content. Related methods, wireless terminal apparatus and computer program products are also described.

### BACKGROUND OF THE INVENTION

The present invention relates to wireless communications, and more particularly, to apparatus, methods and computer program products for providing user note services.

Electronic communications technology has fostered new modes of interacting with the world, new modes of information dissemination and new modes of cultural expression. For example, through the marriage of cellular telephony technology with digital audio and digital photography, a user can capture sights and sounds associated with an event and/or a place, and can convey them to a remote companion in near real time. Chat rooms, instant messaging, and other modalities can be used to create instant virtual communities.

A recently developed technology for social interaction is so-called “note” systems that allow users to post location-associated notes that can be retrieved by other users. For example, a first person may post a note commenting on a particular restaurant, club, shop, etc., at a particular location. Such a note can be subsequently retrieved by a second person upon coming into proximity of the location. In other applications, such notes may be used for commercial purposes, for example, to post restaurant specials, notices of particular events scheduled for a particular venue, and the like. Such notes may also be used for a wide variety of other purposes, e.g., virtual graffiti, gaming, and the like.

An exemplary note system is the GeoNotes system developed by the Swedish Institute of Computer Science (SICS) and deployed in the StockholmOpen.Net open access network. GeoNotes is a JAVA application that may be downloaded and installed on a personal computer (PC) or personal digital assistant (PDA). GeoNotes automatically detects a user's current geographical position in the network and allows the user to write ‘tags’ and graffiti at that place. The system is implemented using a wireless local area network (W-LAN) including wireless access points that are tied to a GeoNotes server that manages notes for multiple locations. The SICS GeoNotes system is described on the World Wide Web at geonotes.sics.se.

### SUMMARY OF THE INVENTION

According to some embodiments of the present invention, a wireless user note service apparatus includes a short range wireless transceiver, and a processor operatively coupled to the short-range wireless transceiver and configured to provide an autonomous wireless user note server that wirelessly receives, locally stores and wirelessly transmits user notes to and from users of the short-range wireless transceiver. The autonomous local wireless user note server may be operative to wirelessly receive, locally store and wirelessly transmit user notes without storing geographical location data in association with the user notes. The autonomous local wireless user note server may also be configured to wireless receive, locally store and wirelessly transmit user notes without communicating the user notes to a central wireless user note repository that stores notes associated with multiple locations. The autonomous local wireless user note server may also be operative to selectively transmit locally stored user notes bases on at least one of a recipient identity and a user note content.

According to some embodiments of the present invention, the short-range wireless transceiver comprises an ad hoc radio networking transceiver, such as a Bluetooth transceiver. In other embodiments, the short-range wireless transceiver may comprise, for example, a wireless access point for a local area network.

According to some embodiments of the present invention, a wireless user note service apparatus comprises an ad hoc networking radio transceiver and a processor operatively coupled to the ad hoc radio networking transceiver and configured to provide a user note server that receives, stores and transmits user notes. The user note server may be operative to receive, locally store and transmit user notes without storing geographical location data in association with the user notes and/or without communicating with a central user note repository that manages notes for multiple radio transceivers.

In further embodiments of the present invention, a wireless terminal comprises a short range wireless transceiver and a processor operatively coupled to the short-range wireless transceiver and configured to provide a wireless user note service client that is operative to send and receive user notes to and from an autonomous local wireless user note server. The wireless user note client may be operative to retrieve and transmit wireless user notes without requiring association of geographical location data with the user notes. The wireless user note client may also be operative to retrieve and post user notes without communicating the user notes to or from a central wireless user note repository that manages notes associated with multiple locations. The short-range wireless transceiver may be configured to wirelessly communicate over a nominal range of about 10 meters or less. For example, the short-range wireless transceiver may be configured to wirelessly communicate according to a Bluetooth protocol.

According to still further embodiments of the present invention, a wireless user note service may be provided. User notes are wirelessly communicated among users using an autonomous local wireless note server. Wirelessly communicating user notes among users using an autonomous local wireless note server may comprise wirelessly receiving a user note from a first user at a short-range wireless transceiver, locally storing the received user note, and wirelessly transmitting the locally stored user notes to a second user via the short-range wireless transceiver. The user note may be communicated between the first and second users by the autonomous local wireless note server without storing geographical location data in association with the user note. The user note may also be communicated between the first and second users without requiring communication of the user note to a central wireless user note repository that manages notes for multiple locations. The wireless receiving and the wireless transmitting occur according to a Bluetooth protocol. The short-range wireless transceiver may comprise a wireless access point for a local area network.

Wirelessly communicating user notes among users using an autonomous local wireless note server may comprise selectively transmitting user notes based on at least one of a user identity and a user note content. Wirelessly communicating user notes among users using an autonomous local wireless note server may comprise transmitting and receiving user notes at a wireless terminal.

According to additional embodiments of the present invention, a user note service may be provided by receiving a user note from a first user at an ad hoc radio networking transceiver, storing the received user note, and transmitting the stored user note to a second user via the ad hoc radio networking transceiver. The user note may be communicated between the first and second users without storing geographical location data in association with the user note and/or without requiring communication of the user note to a central wireless user note repository that manages notes for multiple radio transceivers.

In still further embodiments of the present invention, a computer program product for providing a wireless user note service may be provided. The computer program product comprises program code embodied in a computer-readable medium, the program code comprising program code configured to provide an autonomous local wireless user note server that locally stores user notes wirelessly received by a short-range wireless transceiver and that causes wireless transmission of the user notes from the short-range wireless transceiver. The program code may be configured to communicate a user note between first and second users without storing geographical location data in association with the user note. The program code may also be configured to cause communication of a user note between first and second users without requiring communication of the user note to a central wireless user note repository that manages user notes for multiple locations. The program code may also be configured to cause selective transmission of user notes based on at least one of a user identity and a user note content.

In additional embodiments of the present invention, a computer program product for providing a wireless user note application for a wireless terminal may be provided. The computer program product comprises program code embodied in a computer-readable medium, the program code comprising program code configured to provide a wireless user note client that retrieves and transmits user notes from and to an autonomous local wireless note server. The program code may be configured to retrieve and transmit user notes without requiring association of geographical location data with the user note. The program code may also be configured to retrieve and transmit user notes without requiring communication of the user notes to a central wireless user note repository that manages user notes for multiple locations.

The terms “comprises” and “comprising,” when used herein, are to be taken to specify the presence of stated features, integers, steps or components, but does not preclude the presence or addition of one or more other features, integers, steps, components or groups thereof.

### BRIEF DESCRIPTION OF THE DRAWINGS

FIG. 1 is a block diagram of an apparatus for providing a wireless user note service according to some embodiments of the present invention.

FIG. 2 is a block diagram of an apparatus for providing a wireless user note service according to further embodiments of the present invention.

FIG. 3 is a flowchart illustrating exemplary operations for providing a user note service according to some embodiments of the present invention.

FIG. 4 is a block diagram illustrating an exemplary wireless terminal according to further embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

The present invention may be embodied as apparatus (systems), methods, and/or articles of manufacture, including computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, apparatus and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Some embodiments of the present invention arise from a realization that a relatively simple, low-cost and effective user note service may be provided by using autonomous wireless user note servers that locally receive, store and transmit user notes over a limited range without storing geographical location data with the notes and/or without the need to communicate with a central note repository. There is no need for the node to know it's own position. Consequently, there is no need to compare geographical data. For purposes of the present application, “autonomous” refers to an ability to perform the function described, e.g., receiving, storing and transmitting user notes, without requiring the assistance of other nodes, such as a central repository node or other user note servers. For example, in some embodiments, an autonomous local wireless user note service apparatus may include a Bluetooth or other short-range wireless transceiver coupled to a local processor that implements an autonomous user note server. Because such a Bluetooth node typically would have limited range (e.g., a nominal 10 meters), the need to store location information (e.g., GPS coordinates, street address, or the like) in association with the user note can be eliminated. This can eliminate the need for a central note repository and can simplify operations involved in creating, storing and transmitting notes. It will be appreciated that similar functionality can be provided by other types of wireless transceiver apparatus, including wireless access points that utilize other limited-range radio interfaces.

Notes stored in such an autonomous node can be subject to other filtering or control. For example, notes can be designated as public or private. Bluetooth addresses could be used to tag a note as being limited to certain users, such that, when a designated user enters an area covered by a particular note, he or she can be notified of the existence of the note. Filtering according to area of interest, writer identity, or the like could also be used to limit the number of notifications.

According to further aspects of the present invention, a relatively simple note service may be provided by using devices that communicate according to an ad hoc radio networking protocol, i.e., a radio networking protocol that does not presume a predefined network infrastructure, such as a cellular network, wireless LAN or the Internet. According to such aspects of the present invention, a user note service device could include an ad hoc radio networking transceiver, such as a Bluetooth transceiver, coupled to a processor that implements a local server for user notes, without requiring any other network connection, e.g., a LAN or Internet. Bluetooth may be particularly well suited for such an application, as Bluetooth devices typically can easily find nearby devices and retrieve their services.

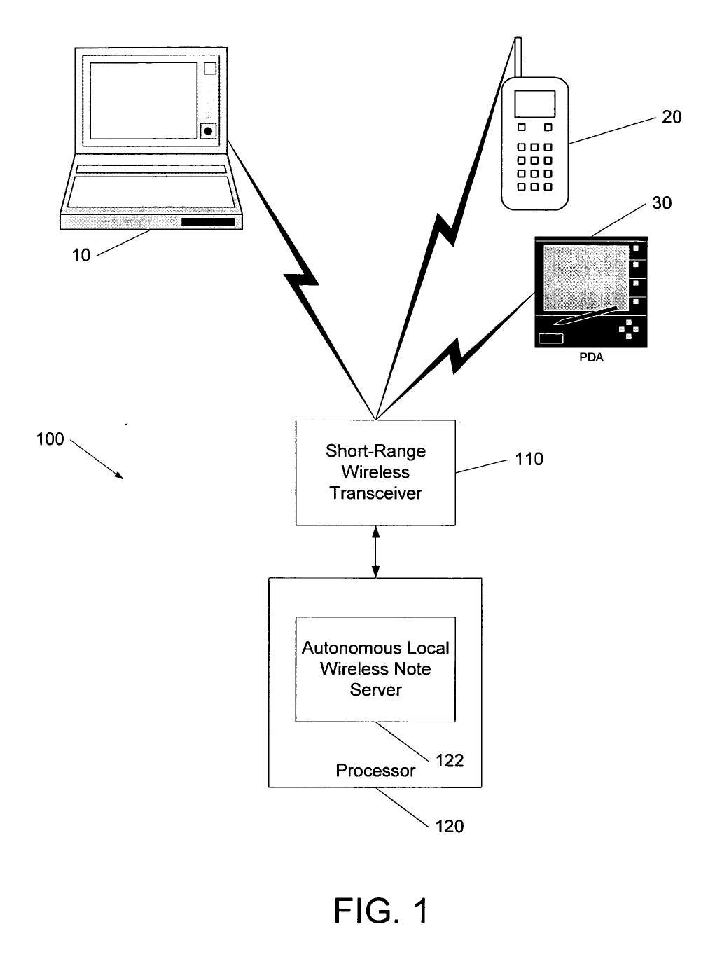

FIG. 1 illustrates an apparatus 100 for providing a wireless note service according to some embodiments of the present invention. The apparatus 100 includes a short-range wireless transceiver 110, coupled to a processor 120 that is configured to provide an autonomous local wireless note server 122, e.g., by running appropriate software that instantiates that autonomous local wireless note server 122. The wireless transceiver 110 is operative to wirelessly communicate with wireless devices, such as a laptop computer 10, a cellular telephone 20 or a PDA 30, each of which is configured to support the user note application.

It will be appreciated that the apparatus 100 may take any of a number of forms within the scope of the present invention. For example, in some embodiments, the apparatus 100 could be a standalone device that lacks any other network connection beyond the radio connections to the devices (e.g., cellphones, PDAs, laptops) for which it serves as a local user note server. For example, such a standalone device could comprise a special-purpose Bluetooth transceiver/processor combination dedicated to provision of an autonomous local note server, or the standalone device could be a multifunction device, such as a laptop computer with a Bluetooth PCMCIA card or a desktop computer with a Bluetooth PCI bus card, that performs wireless user note server functions in addition to other computing functions. In other embodiments, the apparatus could be a networked device, such as an IEEE 810.11b wireless LAN access point, that serves as an autonomous local note server for wireless terminals in its local area, but that also serves as a gateway to a wider network for other functions, such as internet access. For example, such a device could serve as an Internet access point for a limited population of users, e.g., users registered with a particular internet service provider, while also serving as a local autonomous user note server for a wider population of users.

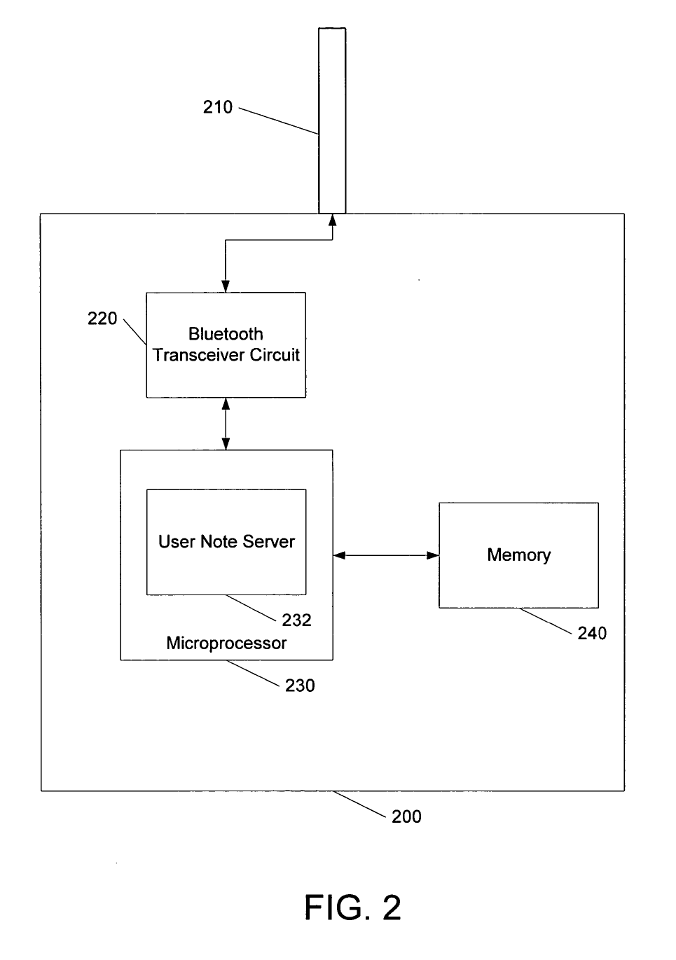

FIG. 2 illustrates an exemplary user note service apparatus 200 according to further embodiments of the present invention. The apparatus 200 includes an ad hoc radio networking transceiver circuit, here shown as a Bluetooth transceiver circuit 220 (e.g., a chipset or ASIC) configured to communicate with wireless devices via an antenna 210 according to the Bluetooth protocol (described at www.bluetooth.com). The apparatus 200 further includes a microprocessor 230 (or equivalent device, such as a microcontroller, digital signal processor or other data processing chip) that, in conjunction with associated memory 240, is configured (programmed) to implement a user note server 232. It will be appreciated that the apparatus 200 could be implemented in other ways, including the use of ad hoc radio networking protocols other than Bluetooth. It will be further appreciated that, although the apparatus 200 could be fixedly associated with a particular geographic location, it could alternatively be associated with an object that is not tied to any particular geographic location, such as a vehicle or a piece of merchandise.

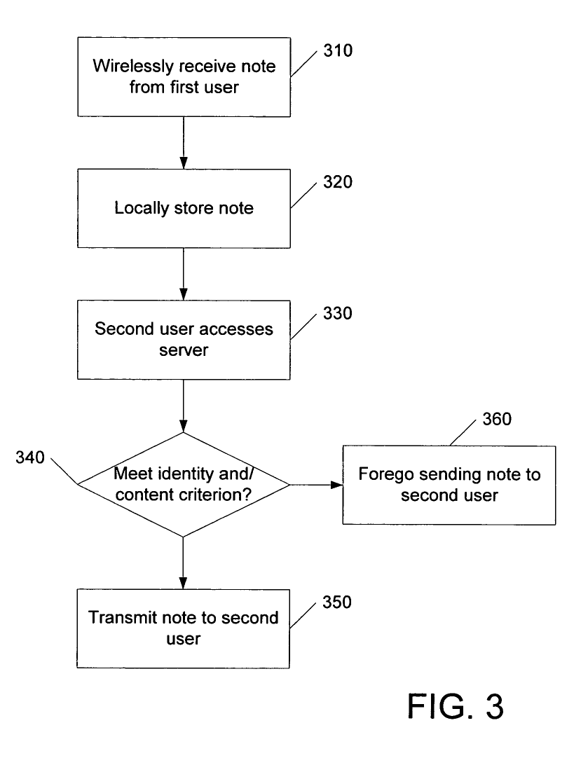

Exemplary operations of a user note server apparatus, such as the apparatus 100, 200 of FIGS. 1 and 2, are shown in FIG. 3. A note is wirelessly received at a wireless note service apparatus from a first user, e.g., according to Bluetooth, 802.11b, infrared, or other wireless protocol (Block 310), and stored (Block 320). A second user accesses the wireless note service apparatus (Block 330). Depending on identity, note content and/or other criteria (Block 340), the note is either sent to the second user (350) or transmission of the note is foregone (Block 360).

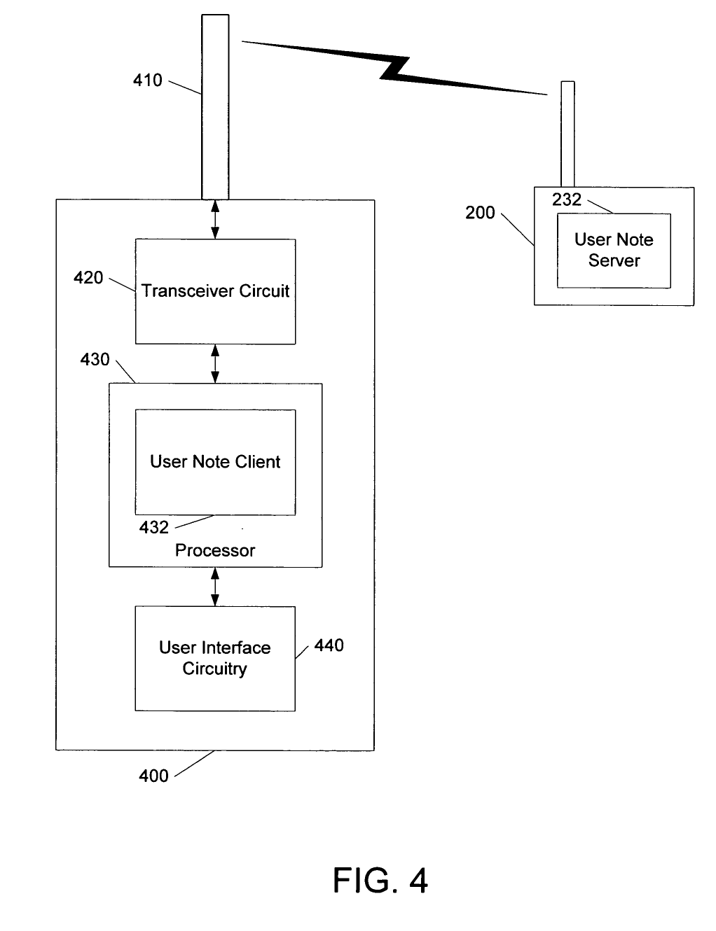

FIG. 4 illustrates an exemplary wireless terminal 400 according to further embodiments of the present invention. The terminal 400 includes a short-range wireless transceiver circuit 420 (e.g., a Bluetooth transceiver) that transmits and receives signals via an antenna 410 and that is operatively coupled to a processor 430 that controls user interface circuitry 440, such as a display, keypad, mouse or the like. The processor 430 is further configured (e.g., programmed) to provide a wireless user note client 432 that is operative to communicate user notes with an autonomous local user note server, here shown as the autonomous local wireless user note server 232 of the apparatus 200 of FIG. 2. In particular, the wireless user note client 432 is operative to retrieve and transmit user notes using such a wireless note server 232 without requiring association of geographic data with the notes and/or without requiring communication with a central note repository that manages notes for multiple locations. For example, the wireless note client might be a Java program that interacts with the wireless user note server 232 to store and retrieve user notes to and from the server 232. It will be appreciated that the terminal 400 can take many forms, including, but not limited to, a cellular telephone, PDA, or a laptop computer with wireless capability.

In the drawings and specification, there have been disclosed exemplary embodiments of the invention. Although specific terms are employed, they are used in a generic and descriptive sense only and not for purposes of limitation, the scope of the invention being defined by the following claims.

1. A wireless user note service apparatus, comprising:
a short range wireless transceiver; and
a processor operatively coupled to the short-range wireless transceiver and configured to provide an autonomous local wireless user note server that wirelessly receives, locally stores and wirelessly transmits user notes to and from users of the short-range wireless transceiver.

2. An apparatus according to claim 1, wherein the autonomous local wireless user note server is operative to wirelessly receive, locally store and wirelessly transmit user notes without storing geographical location data in association with the user notes.

3. An apparatus according to claim 1, wherein the autonomous local wireless user note server is configured to wireless receive, locally store and wirelessly transmit user notes without communicating the user notes to a central wireless user note repository that stores notes associated with multiple locations.

4. An apparatus according to claim 1, wherein the short-range wireless transceiver comprises an ad hoc radio networking transceiver.

5. An apparatus according to claim 1, wherein the short-range wireless transceiver is configured to wirelessly communicate according to a Bluetooth protocol.

6. An apparatus according to claim 1, wherein the short-range wireless transceiver comprises a wireless access point for a local area network.

7. An apparatus according to claim 1, wherein the autonomous wireless user note server is further operative to selectively transmit locally stored user notes based on at least one of a recipient identity and a user note content.

8. A wireless user note service apparatus, comprising:
an ad hoc networking radio transceiver; and
a processor operatively coupled to the ad hoc radio networking transceiver and configured to provide a user note server that receives, stores and transmits user notes.

9. An apparatus according to claim 8, wherein the user note server is operative to receive, locally store and transmit user notes without storing geographical location data in association with the user notes.

10. An apparatus according to claim 8, wherein the user note server is configured to receive, locally store and transmit user notes without communicating the user notes to a central wireless user note repository that stores notes associated with other user note servers.

11. An apparatus according to claim 10, wherein the ad hoc radio networking transceiver comprises a Bluetooth transceiver.

12. A wireless terminal, comprising:
a short range wireless transceiver; and
a processor operatively coupled to the short-range wireless transceiver and configured to provide a wireless user note service client that is operative to send and receive user notes to and from an autonomous wireless user note server.

13. A terminal according to claim 12, wherein the wireless user note client is operative to retrieve and transmit wireless user notes without requiring association of geographical location data with the user notes.

14. A terminal according to claim 12, wherein the wireless user note client is operative retrieve and create user notes without communicating the user notes to or from a central wireless user note repository that manages notes associated with multiple locations.

15. A terminal according to claim 12, wherein the short-range wireless transceiver comprises an ad hoc radio networking transceiver.

16. A method of providing a wireless user note service, the method comprising:
wirelessly communicating user notes among users using an autonomous local wireless note server.

17. A method according to claim 16, wherein wirelessly communicating user notes among users using an autonomous local wireless note server comprises:
wirelessly receiving a user note from a first user at a short-range wireless transceiver;
locally storing the received user note; and
wirelessly transmitting the locally stored user note to a second user via the short-range wireless transceiver.

18. A method according to claim 17, wherein the user note is communicated between the first and second users by the autonomous wireless note server without storing geographical location data in association with the user note.

19. A method according to claim 17, wherein the user note is communicated between the first and second users without requiring communication of the user note to a central wireless user note repository that manages user notes for multiple locations.

20. A method according to claim 17, wherein the short-range wireless transceiver comprises an ad hoc radio networking transceiver.

21. A method according to claim 17, wherein the wireless receiving and the wireless transmitting occur according to a Bluetooth protocol.

22. A method according to claim 17, wherein the short-range wireless transceiver comprises a wireless access point for a local area network.

23. A method according to claim 16, wherein wirelessly communicating user notes among users using an autonomous local wireless note server comprises selectively transmitting user notes based on at least one of a user identity and a user note content.

24. A method according to claim 16, wherein wirelessly communicating user notes among users using an autonomous wireless note server comprises transmitting and receiving user notes at a wireless terminal.

25. A method of providing a user note service, the method comprising:
receiving a user note from a first user at an ad hoc radio networking transceiver;
storing the received user note; and
transmitting the locally stored user note to a second user via the ad hoc radio networking transceiver.

26. A method according to claim 25, wherein the user note is communicated between the first and second users without storing geographical location data in association with the user note.

27. A method according to claim 25, wherein the user note is communicated between the first and second users without requiring communication of the user note to a central wireless user note repository that manages notes for multiple radio transceivers.

28. A computer program product for providing a wireless user note service, the computer program product comprising program code embodied in a computer-readable medium, the program code comprising:
program code configured to provide an autonomous local wireless user note server that locally stores user notes wirelessly received by a short-range wireless transceiver and that causes wireless transmission of the user notes from the short-range wireless transceiver.

29. A computer program product according to claim 28, wherein the program code is configured to communicate a user note between the first and second users by the autonomous local wireless note server without storing geographical location data in association with the user note.

30. A computer program product according to claim 28, wherein the program code is configured to cause communication of a user note between first and second users of the short range wireless transceiver without requiring communication of the user note to a central wireless user note repository that manages user notes for multiple locations.

31. A computer program product for providing a wireless user note application for a wireless terminal, the computer program product comprising program code embodied in a computer-readable medium, the program code comprising:
program code configured to provide a wireless user note client that retrieves and transmits user notes from and to an autonomous local wireless note server.

32. A computer program product according to claim 31, wherein the program code is configured to retrieve and transmit user notes without requiring association of geographical location data with the user notes.

33. A computer program product according to claim 31, wherein the program code configured to retrieve and transmit user notes without requiring communication of the user notes to a central wireless user note repository that manages user notes for multiple locations.
